(19) United States
(12) Patent Application Publication
(10) Pub. No.: US 2013/0298140 A1
(43) Pub. Date: Nov. 7, 2013

(54) Method and Apparatus for Displaying Data from a Plurality of Concurrent Operating System Environments

(71) Applicants: Christopher M. Wolfe, Antioch, IL (US); Andrew N. Tzakis, Vernon-Hills, IL (US)

(72) Inventors: Christopher M. Wolfe, Antioch, IL (US); Andrew N. Tzakis, Vernon-Hills, IL (US)

(73) Assignee: Motorola Mobility, Inc., Libertyville, IL (US)

(21) Appl. No.: 13/462,523

(22) Filed: May 2, 2012

(51) Int. Cl. G06F 9/46; G06F 3/00

(52) U.S. Cl. 719/319

(57) ABSTRACT

A method includes running a first operating system environment and a second independent operating system environment, with both operating system environments utilizing a common kernel. The method includes mapping a home screen of the first operating system environment to a workspace of the second operating system environment, and generating display data for a combined workspace using the mapping of the home screen to the workspace. The method may generate the display data for the combined workspace, including at least one selectable application icon for selecting an application associated with the first operating system environment, and at least a second selectable application icon for selecting an application associated with the second operating system environment. A plurality of home screens may be mapped to a plurality of workspaces to create a plurality of combined workspaces. An apparatus having at least one processor is operative to perform the disclosed methods.

### CROSS-REFERENCE TO RELATED APPLICATIONS

The present disclosure is related to copending U.S. patent application No. ______, Attorney Docket No. CS39607, “METHOD AND APPARATUS FOR DISPLAYING ACTIVE OPERATING SYSTEM ENVIRONMENT DATA WITH A PLURALITY OF CONCURRENT OPERATING SYSTEM ENVIRONMENTS,” and U.S. patent application No. ______, Attorney Docket No. CS39608, “METHOD AND APPARATUS FOR PROVIDING CONTEXTUAL INFORMATION BETWEEN OPERATING SYSTEM ENVIRONMENTS,” both of which are assigned to the same assignee as the present application, and both of which are hereby incorporated by reference herein.

### FIELD OF THE DISCLOSURE

The present disclosure relates generally to operating systems and operating system environments.

### BACKGROUND

Various operating systems provide features and applications that are often specific to the given operating system. For this reason, it has become useful for computing devices, including handheld mobile devices, to be capable of running more than one operating system environment. By running more than one operating system environment on a device, users are able to access the features and applications associated with each of the operating system environments, thereby enhancing the capabilities and functions of the device.

In the past, virtualization techniques have been used to accomplish running multiple operating system environments; however such approaches require emulation of an entire machine which is resource intensive. Systems have now been developed that enable actual running of multiple operating system environments without the need for such resource intensive machine emulation. Such systems utilize a common kernel where the operating system environments may be considered middleware, in that, some services related to the various applications may be supported within the confines of the environment. Therefore, in these systems, the operating system environments co-exist independently, and do not require virtualization as in the past. Devices supporting these multiple environments therefore enable users to access and enjoy the features of the operating systems and their associated data such as applications.

Nevertheless, some demarcation between the operating system environments must exist for the purpose of presentation to the device user. The environments usually provide their own unique approach to how associated data is displayed by the operating system. In some cases, the user may be compelled to switch display views in order to work with one or another operating system environment. Being forced to switch views in this manner negatively impacts user experience because the work or operating contexts in which the user was engaged can be lost or muddled among the various views. Furthermore, any given operating system environment will not understand, and therefore will be incapable of interpreting, data associated with a different operating system environment and any associated data or working context.

### BRIEF DESCRIPTION OF THE DRAWINGS

FIG. 1 is a block diagram that conceptually shows mapping of home screens of a first operating system environment to workspaces of a second operating system environment, in accordance with the embodiments.

FIG. 2 is block diagram that exemplifies a mapped combined workspace that combines home screen display data with workspace display data to create the combined workspace image in accordance with the embodiments.

FIG. 3 is diagram of an apparatus with a plurality of operating system environments, a single kernel and multi-environment display data handling logic in accordance with an embodiment.

FIG. 4 is flow chart illustrating high level operation of the embodiments.

FIG. 5 is a flow chart illustrating details of one embodiment.

FIG. 6 is a flow chart illustrating mapping and user input handling on the combined display in accordance with various embodiments.

### DETAILED DESCRIPTION

The various embodiments disclosed provide an enhanced user experience when using multiple operating system environments having a common kernel. The embodiments combine the graphical display data from one operating system environment with the graphical display data from at least a second operating system environment to create a combined graphical display. For example, in one embodiment, mobile device home screens of a first operating system environment are mapped to workspaces of a second operating system environment. In this example, when the user switches between workspaces, the user also switches between home screens, which results in a smoother and more consistent user experience in working with the two operating system environments

The present disclosure provides a method that includes running a first operating system environment and a second operating system environment, the first and second operating system environments being independent from each other, both operating system environments utilizing a common kernel. The method continues with mapping a home screen of the first operating system environment to a workspace of the second operating system environment, and generating display data for a combined workspace using the mapping of the home screen to the workspace.

The method may include generating the display data for the combined workspace, including at least one selectable application icon for selecting an application associated with the first operating system environment, and at least a second selectable application icon for selecting an application associated with the second operating system environment.

The method may include mapping a plurality of home screens of the first operating system environment, to a corresponding plurality of workspaces of the second operating system environment; and generating display data for a plurality of corresponding combined workspaces using a corresponding mapping, corresponding to each combined workspace, with at least one combined workspace including at least one selectable application icon of an application of the first operating system environment.

Mapping a home screen of the first operating system environment to a workspace of the second operating system environment may include, for example, mapping positional coordinates of the home screen to positional coordinates of the workspace.

In one embodiment, mapping a home screen of the first operating system environment to a workspace of the second operating system environment, includes mapping an Android™ home screen with a Linux® workspace where the first operating system environment is an Android™ operating system environment and the second operating system environment is a Linux® operating system environment. The method may map each Android™ home screen, of a plurality of Android™ home screens, to a corresponding workspace of a plurality of corresponding Linux® workspaces.

The method may include switching, in response to selection input, from a first combined workspace of the plurality of combined workspaces, to a second combined workspace of the plurality of combined workspaces, and maintaining a current state of a least one application window or at least one widget, such that returning to the first combined workspace in response to another selection input, returns the at least one application window or the at least one widget to the same current state.

The method may include displaying the combined workspace on a display, the combined workspace including first display data associated with the first operating system environment, having at least one selectable application icon associated with the first operating system environment, and second display data associated with the second operating system environment, including at least a second selectable application icon associated with the second operating system environment, both icons being selectable within the combined workspace. The method may display the combined workspace on a display, including first display data having at least one active widget associated with the first operating system environment, and second display data having at least a second selectable application icon associated with the second operating system environment, both the widget and the icon being within the combined workspace.

Another aspect of the disclosed embodiments is an apparatus having at least one processor, operative to run a first operating system environment and a second operating system environment. The first and second operating system environments are independent from each other and both utilize a common kernel. The apparatus includes multi-environment display data handling logic that is operative to map a home screen of the first operating system environment to a workspace of the second operating system environment, and generate display data for a combined workspace using the mapping of the home screen to the workspace.

The multi-environment display data handling logic is operative to generate the display data for the combined workspace, including at least one selectable application icon for selecting an application associated with the first operating system environment, and at least a second selectable application icon for selecting an application associated with the second operating system environment.

The multi-environment display data handling logic is operative to map a plurality of home screens of the first operating system environment, to a corresponding plurality of workspaces of the second operating system environment, and generate display data for a plurality of corresponding combined workspaces using a corresponding mapping, corresponding to each combined workspace, with at least one combined workspace including at least one selectable application icon of an application of the first operating system environment.

The multi-environment display data handling logic is operative to map a home screen of the first operating system environment to a workspace of the second operating system environment by, for example, mapping positional coordinates of the home screen to positional coordinates of the workspace.

In one embodiment, the multi-environment display data handling logic is operative to map a home screen of the first operating system environment to a workspace of the second operating system environment, including mapping an Android™ home screen with a Linux® workspace where the first operating system environment is an Android™ operating system environment and the second operating system environment is a Linux® operating system environment. The multi-environment display data handling logic is operative to map each Android™ home screen, of a plurality of Android™ home screens, to a corresponding workspace of a plurality of corresponding Linux® workspaces.

The multi-environment display data handling logic is operative to switch, in response to selection input, from a first combined workspace of the plurality of combined workspaces, to a second combined workspace of the plurality of combined workspaces, and maintain a current state of a least one application window or at least one widget, such that returning to the first combined workspace in response to another selection input, returns the at least one application window or the at least one widget to the same current state.

The apparatus may include a display, operatively coupled to the at least one processor, to display the combined workspace. The displayed combined workspace may include first display data associated with the first operating system environment, and have at least one selectable application icon associated with the first operating system environment, and second display data associated with the second operating system environment, including at least a second selectable application icon associated with the second operating system environment. Both icons are selectable within the combined workspace.

The displayed combined workspace may include first display data, having at least one active widget associated with the first operating system environment, and second display data having at least a second selectable application icon associated with the second operating system environment. Both the widget and the icon are displayed within the combined workspace.

Another aspect of the disclosed embodiments is a computer readable, non-volatile, non-transitory memory, storing executable instructions for execution on at least one processor. When executed, the executable instructions cause the at least one processor to run a first operating system environment and a second independent operating system environment, with both operating system environments utilizing a common kernel.

The executable instructions also cause the at least one processor to map a home screen of the first operating system environment to a workspace of the second operating system environment, and generate display data for a combined workspace using the mapping of the home screen to the workspace.

The executable instructions may also cause the at least one processor to map a plurality of home screens of the first operating system environment, with a corresponding plurality of workspaces of the second operating system environment, and generate display data for a plurality of corresponding combined workspaces using a corresponding mapping, corresponding to each combined workspace, with at least one combined workspace including at least one selectable application icon of an application of the first operating system environment.

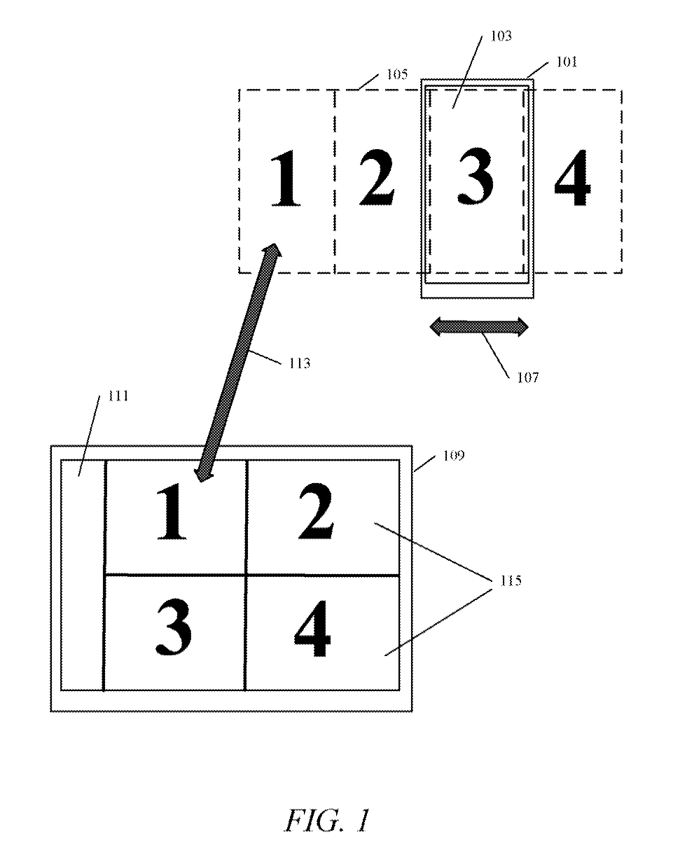

Turning now to the drawings wherein like numerals represent like components, FIG. 1 illustrates a conceptual representation of the various embodiments herein disclosed. A mobile device 101 includes the integrated display 103 capable of displaying various home screens 105. The various home screens 105 (home screens 1 through 4) are associated with a first operating system environment utilized by the mobile device 101, and provide for, among other features, useful organization of application icons. For example, a user may position various icons, such as, but not limited to, application icons, image icons, widgets, etc. on a given home screen. The user may then scroll to the home screen having a desired icon for a desired application, etc., and select the icon to launch the application or otherwise access the file corresponding to the icon. The home screens may allow the user to launch an application within the perimeter of the home screen, by, for example, clicking a mouse cursor, or by using a touch screen, to provide selection input to select and activate a desired application icon. Additionally, scrolling to another home screen may also allow scrolling between such launched applications. As shown in FIG. 1, the home screens one through four are scrollable as represented by scrolling arrow 107. The home screens may be scrolled using a touch screen graphical user interface (GUI), a track ball, or any other suitable user interface. In accordance with the various embodiments, the mobile device 101 may interact with a larger display 109.

The larger display 109 may be used to display various workspaces 115, that are associated with a second operating system environment that may be different from the operating system environment associated with the home screens 105 displayed by mobile device 101. The mobile device 101 may use one or more operating system environments together, or may launch operating system environments as needed. The operating system environment displayed on the display 109 may include an operating system environment toolbar 111 as shown. The workspaces 115, are user selectable and the user can toggle from one workspace to another workspace, by for example, selecting a workspace icon or button, or by hitting a workspace hotkey on a keypad, or by hitting a workspace toggle function on either a touchscreen, a keypad, a keyboard, or by mouse cursor selection, etc. When one of the workspaces is selected, that workspace may take up the entirety of the display screen of display 109, with the exception of the toolbar 111, which may remain in a constant position. The toolbar 111, may remain in place even as the user toggles through the various workspaces. For example, the user may toggle between various workspaces 1 through 4. The workspaces serve as, for example, a set of different “desktops” where various utilities or applications may be active. For example, a user may have an email program and a browser open in workspace 1. The user may toggle to workspace 2 and launch a photo editing application and perform photo editing. The user can toggle back to workspace 1, and resume working with the email program and/or browser. In other words, a “workspace” enables a user to organize applications in use so that the user does not have to shut down or resize application windows, or reorganize windows to perform other tasks requiring different applications or work contexts. For example, the user may have an application open for a communication context, such as email, in one workspace, and a set of application windows related to computer programming or debugging, i.e. a computer programming context, in another workspace. The user can toggle between the different workspaces and therefore between different groupings or arrangements of applications and/or application windows.

As shown in FIG. 1, the various embodiments may provide a mapping 113 between the home screens for the first operating system environment and the workspaces of the second operating system environment. The term “display” as used herein refers to a device that displays “display data” to form an image or images, such as, but not limited to, a home screen, a workspace, a computer desktop, a gaming background, a video, an application window, a picture, etc. Examples of a display include a television, computer monitor, etc., or an integrated display as found in electronic devices such as a laptop computer, handheld computing device, mobile telephone, PDA, etc. The display device may employ any appropriate display technology, such as for example, a CRT, LCD flat panel, LED flat panel, plasma screen, etc.

The terms “screen,” “home screen,” and “workspace” are used in reference to an “image” which refers generally to what is “displayed” on a display. That is, an image, including a “screen,” “home screen,” and/or “workspace” may be displayed on a display. In one aspect, a home screen and/or a workspace may consist of a “background” and a “foreground,” where the background includes a background image and/or background image objects, and the foreground includes various foreground image objects. Examples of “images” include, but are not limited to, a computer desktop, a gaming background, a video, an application window, an icon, a widget, etc. In other words, the term “image” may refer to a background, or may refer individually, or collectively, to elements or objects in the foreground, of hovering over, a background image. Therefore, image “objects” may be, but are not limited to, application windows, icons, widgets, etc., and may be, in some scenarios, moveable, by drag-and-drop operations, about or within a home screen and/or workspace. The term “display data” is used interchangeably herein with the term “image data” and refers to the information (data, or digital information) that the display interprets and/or decodes to “display,” i.e. show the user, an image such as a workspace or home screen, as well as any associated elements or objects in the background and/or foreground of home screens or workspaces, etc.

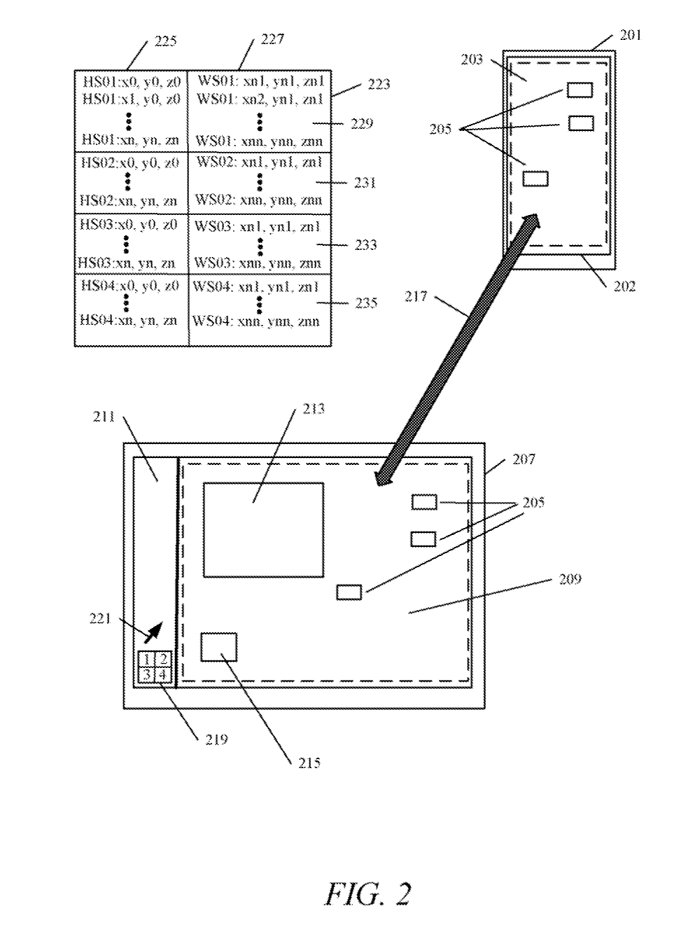

FIG. 2 is another example showing the various advantages of the herein disclosed embodiments. The mobile device 201 displays a home screen 203 as illustrated generally by the dotted line within the perimeter of the mobile device 201 integrated display 202. The home screen 203 may include a plurality of icons 205 which may be application icons or widgets that are associated with a first operating system environment. The home screen 203 is likewise associated with the first operating system environment. For example, in one embodiment, the mobile device 201 may operate using an Android™ operating system environment and may display various Android™ widgets and/or application icons. In accordance with the embodiments, the mobile device 201 may interact with a peripheral device that includes display 207. Display 207 may be larger than the mobile device 201 integrated display 202 and, in accordance with the embodiments, may display a combined workspace 209. The combined workspace 209 is created by mapping 217 the home screen 203 of a first operating system environment of mobile device 201, to a corresponding workspace of a second operating system environment. That is, the combined workspace 209 includes first display data from a home screen associated with a first operating system environment, and second display data from a workspace associated with a second operating system environment.

Among the advantages of the embodiment illustrated by FIG. 2, an application window 213, associated with a second operating system environment, may be displayed on the combined workspace 209 along with a plurality of icons 205, which are associated with a first operating system environment. That is, various image objects such as application window 215, which is also associated with the second operating system, may be shown on the same display screen, within the same combined workspace 209, along with various image objects associated with a first operating system environment. A toolbar 211, which may be associated with the first or the second operating system environment, may also be displayed. The toolbar 211 may include a workspace selection icon 219. By using mouse cursor 221, a touchscreen function, or any other suitable selection input mechanism, a user may select one of the workspaces 1 through 4 to switch, i.e. toggle, to that selected workspace. In accordance with the embodiments, a number of home screens may be mapped to a corresponding number of workspaces to create a corresponding number of combined workspaces. The workspace selection icon 219 may be used to toggle between the various combined workspaces. The workspace selection icon 219 may be located anywhere on the display and need not be in the toolbar 211. The workspace selection icon 219 may be located within the combined workspace 209.

In operation of the embodiment exemplified in FIG. 2, the home screens of the first operating system environment are mapped to workspaces of the second operating system environment. In this example, the combined workspace 209, as illustrated generally by the dotted line within the perimeter of the display 207, may show image objects from a home screen of the first operating system environment, along with image objects from a workspace of a second operating system environment. In this example, the icons 205 (and any widgets or other objects) that the user associated with the mapped home screen 203 would be displayed in the combined workspace 209. Likewise, the windows 213 and 215 may be associated with the workspace of the second operating system environment, and that workspace has been mapped with the given home screen. In other words, because of the mapping 217 between the home screens and the workspaces, the combined workspace 209 will show those image objects which the user associated with the mapped home screen 203 and its corresponding workspace. The user may switch away, that is, toggle, to another combined workspace, (i.e. which maps another home screen to another workspace), and back again to, for example, the combined workspace 209 shown in FIG. 2.

The mapping between a home screen and a workspace may be accomplished in various ways in accordance with the embodiments. For example, position coordinates of a home screen may be mapped to position coordinates of a workspace to generate mapping data 223. The mapping data 223 includes a home screen column 225 and a workspace column 227. In one example, a reference point such as a corner, of a first home screen, “HS01” may be represented by position coordinates x0, y0 and z0. The entirety of the first home screen is represented by a set of position coordinates from x0, y0, z0 to xn, yn, zn. In one embodiment, these home screen coordinates may be mapped to corresponding position coordinate points within a workspace. For example, the mapping data 223 includes rows 223 that map a first home screen “HS01” to a first workspace “WS01.” The home screen position coordinates may be mapped to any suitable area of the corresponding workspace. For example, a first home screen position coordinate HS01: x0,y0,z0 is shown mapped to a first workspace position coordinate WS01:xn1,yn1,zn1. In the FIG. 2, example, the mapping proceeds along an x-axis of the home screen and workspace, i.e., HS01:x1,y0,z0 is mapped to WS01:xn2,yn1,zn1. The mapping may continue similarly until all home screen position coordinates are accordingly mapped to workspace position coordinates as shown by rows 229. The mapping data 223 also includes rows 231 that map a second home screen to a second workspace, rows 233 that map a third home screen to a third workspace, and rows 235 that map a fourth home screen to a fourth workspace.

As would be understood, any number of home screens may be mapped to any number of workspaces in accordance with the embodiments. Furthermore, although the example mapping data 223 shows a mapping between a single home screen and a single corresponding workspace, the embodiments are not limited to this scheme. For example, in an alternative embodiment, more than one home screen may be mapped to a single workspace and vice versa. Also, the embodiments are not limited to mapping between the home screens and/or workspaces of only two operating system environments. In one example, the mapping data 223 may include a third column that maps a home screen or workspace of a third operating system environment to the workspace of the second operating system environment.

The mapping 217, in accordance with the embodiments, is not limited to a direct position coordinate to position coordinate mapping. Various approaches may be employed such as distortion or stretching of the home screen to fit into, or fit across, a larger section of a workspace. In other embodiments, the mapping may not be over a contiguous section of the workspace. That is, portions of the home screen may be mapped to portions of the workspace and the portions may not be contiguous portions. It is to be understood that the position coordinates of a home screen and of a workspace, may be related to display data that includes image pixels in some embodiments. In other words, first display data associated with the first operating system environment may be mapped to second display data associated with the second operating system environment to form combined display data, i.e. the combined workspace. The combined display data may include, but is not limited to, appropriate color, brightness, transparency or opaqueness information to determine, and properly display, background and foreground image objects within the combined workspace. For example, the depth or “z” coordinate may be a luminescence, transparency or some other pixel characteristic value. Furthermore, the “x, y, z” coordinates may include various pixel characteristic parameters as understood by those of ordinary skill. In other words, the coordinates “x,y,z” are used only for example and for purposes of explanation. The mapping data 223 may provide any detailed information needed to accomplish the mapping 217.

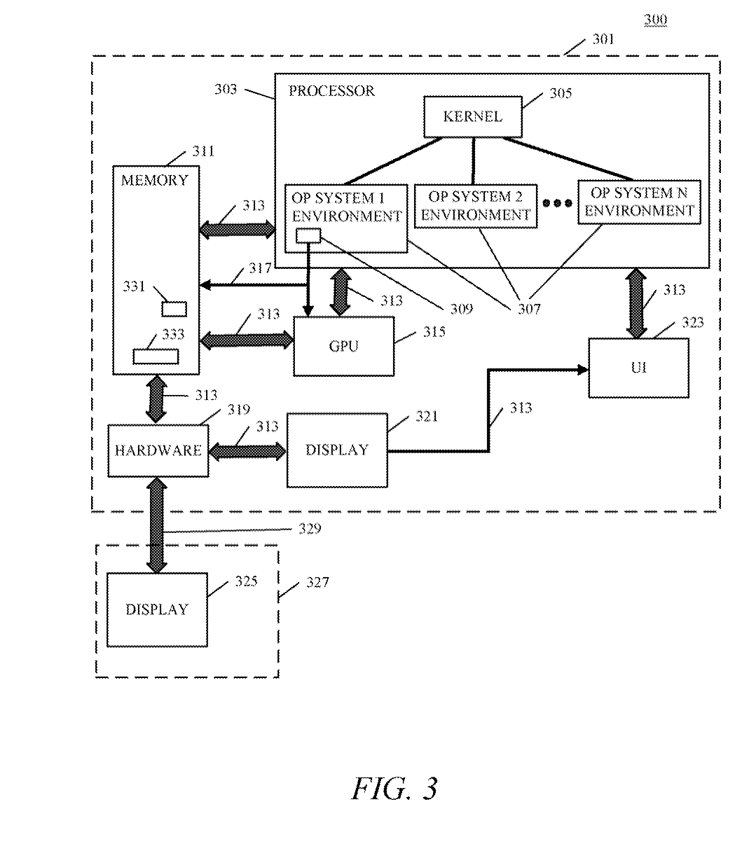

Further details of the various embodiments are best understood with reference to FIG. 3. FIG. 3 illustrates a block diagram of an apparatus 300 in accordance with various embodiments. For example, the apparatus 300 may include a mobile device 301 operatively connected via a communication bus 329 to a peripheral device 327 that may include a display 325. The mobile device 301 includes programmable processor 303 (i.e. a CPU) and graphics processing unit (GPU) 315, which are operatively coupled via a communication bus 313. The communication bus 313 may run throughout the mobile device 301, providing operative coupling to the various components and circuitry contained within the mobile device 301. Therefore, in accordance with embodiments, device components, circuitry, and the like, may be operatively coupled via the communication bus 313. In other words, various intervening device components, circuitry, and the like, may exist in between, and/or along, the communication path between any two or more operatively coupled components. As shown in FIG. 3, the programmable processor 303 is operatively coupled by the communication bus 313 to memory 311 and to a user interface (UI) 323. The memory 311 is in turn operatively coupled, via the communication bus 313, to hardware 319 that drives an integrated display 321. The integrated display 321 is operatively coupled to hardware 319 via the same communication bus 313. The display 321 also provides the functions of a graphical user interface (GUI) of the mobile device 301. Therefore, the display 321 also interfaces with, and is operatively coupled to, the programmable processor 303 via the communication bus 313 as part of the UI 323. The UI 323 may include a track ball mouse, touch sensitive elements, physical switches, gyroscopic position sensors, etc. The display 321 may provide a touchscreen functionality that is also therefore operatively coupled, via the communication bus 313, to the user interface 323. That is, the display 321 may provide a GUI with touchscreen capability in addition to cursor control click to provide selection input and or drag and drop input functionality.

In accordance with the embodiments, the programmable processor 303 may run various operating system environments, such as operating system environment 1, operating system 2 environment, and so on through an N-th operating system environment. In other words, the programmable processor 303 is operative to run one or more of the various operating system environments 307, concurrently. The plurality of operating system environments 307 are each completely autonomous and can exist and function independently from one another. One or more of the operating system environments may be run concurrently, and each operating system environment utilizes a common kernel 305. In other words, each one of the operating system environments is completely autonomous and may exist and function completely independently, without any of the other operating system environments being executed. The operating system environments provide “environments,” in that, for example, all necessary libraries, toolkits, windowing, etc., is present within the environment to enable an application associated with the operating system environment to function. The common kernel 305 provides fundamental interaction at the hardware level of mobile device 301. For example, the common kernel 305 may provide required operating system tasks such as program loading, system resource allocation, handling device input and output, and some memory management functions. The common kernel 305 may be created as an object-oriented design that can interface, and enable communication with, programming objects within the various operating system environments 307.

Examples of operating system environments include, but are not limited to, Android™, Ubuntu®, Linux® based operating systems, etc. In one example embodiment, the mobile device 301 may be connected to the peripheral device 327 by way of a docking port that provides the communication bus 329. In this example, the mobile device 301 display data may be shown on display 325 which may be larger in dimensions than the integrated display 321.

In accordance with the various embodiments, the apparatus 300 includes multi-environment display data handling logic 309. The multi-environment display data handling logic 309 may be contained within one or more of the various operating system environments 307. However, for the example embodiment illustrated in FIG. 3, the first operating system environment is shown as including the multi-environment display data handling logic 309. The multi-environment display data handling logic 309 may also exist independently from any of the operating system environments in some embodiments. The multi-environment display data handling logic 309 is operatively coupled to the memory 311 and also to the GPU 315 via communication path 317 which may be implemented over the internal communication bus 313. Therefore the communication path 317 is a schematic representation of a communication path between the multi-environment display handling logic 309 and the memory 311 and GPU 315, and may be implemented via any suitable communication pathway. That is, it is to be understood that the multi-environment display data handling logic 309 achieves the objectives of the embodiments by communicating with the GPU 315 and memory 311 via the communication bus 313. In accordance with various embodiments, the multi-environment display data handling logic 309 combines into a workspace of the second operating system environment, display data associated with the first operating system environment, so that a combined workspace may be achieved.

The term “logic” as used herein may include software and/or firmware executing on one or more programmable processors (including CPUs and/or GPUs), and may also include ASICs, DSPs, hardwired circuitry (logic circuitry), or combinations thereof. For the example embodiment illustrated by FIG. 3, the multi-environment display data handling logic 309 may be executable instructions stored in memory 311, which is a non-volatile, non-transitory memory. Furthermore, the operating system environments 307, and the kernel 305, may also consist of executable instructions that are executed by the programmable processor 303, and that are stored in memory 311 for access by the programmable processor 303 as necessary. In some embodiments, the multi-environment display data handling logic 309 may be object oriented software or firmware that is executed by processor 303 only when more than one operating system environment is executed by the processor 303.

Although the example provided by FIG. 3 illustrates the operating system environments, kernel 305 and multi-environment display data handling logic 309 as executed by the programmable processor 303, which is located on the mobile device 301, this functionality may be, partially or collectively, alternatively located within the peripheral device 327. In other words either the peripheral device 327 or the mobile device 301 may contain some of, all of, or various components of, the logic and other functionality described with respect to FIG. 3 and would still remain in accordance with the embodiments herein disclosed. In other words, an apparatus in accordance with the embodiments may be the apparatus 300, or may be the mobile device 301 individually, or the peripheral device 327 individually.

As mentioned briefly above, in some embodiments, the apparatus 300 may include the peripheral device 327 which may further have a docking station, such that the mobile device 301 may be docked within the peripheral device 327 and obtain the benefit of the larger display 325 as well as other possible peripheral functions. One example of such a peripheral device is the Motorola Lapdock® product.

Although the communication bus 329, which may be any appropriate interface, is shown connected directly to the larger display 325, it is to be understood that various other hardware and components may exist in the peripheral device intervening between the hardware 319 and the display 325. In other words, FIG. 3 is a diagram provided as an example and is not to be construed as a complete schematic diagram of a particular implementation of either a mobile device or the peripheral device. FIG. 3 provides an example for the purpose of describing to those of ordinary skill how to make and use the various embodiments. Therefore FIG. 3 is limited to showing only those components necessary to describe the features and advantages of the various embodiments to those of ordinary skill. It is to be understood that various other components, circuitry, and devices may be necessary in order to implement a complete functional apparatus and that those various other components, circuitry, devices, etc., are understood to be present by those of ordinary skill.

In accordance with the embodiments, the multi-environment display data handling logic 309 may map home screens of the first operating system environment to workspaces of the second operating system environment. This mapping may be recorded as mapping data 331 stored in memory 311. By using the mapping data 331, the multi-environment display data handling logic 309 may generate combined workspace display data 333.

The combined workspace display data 333 may be provided to hardware 319 for display on either display 321, or on the larger display 325 of the peripheral device 327. In one example embodiment, the first operating system environment may be an Android™ operating system environment that provides home screens one through four as illustrated in FIG. 1. The second operating system environment maybe a Linux® based operating system environment that includes workspaces one through four, also as illustrated in FIG. 1. The multi-environment display data handling logic 309 creates a mapping between the home screens of the first operating system environment and the workspaces of the second operating system environment to create various combined workspaces.

The multi-environment display data handling logic 309 may handle display data from any of the operating system environments 307, and send data to shared memory space of memory 311, to the GPU 315, or combinations of both as appropriate. For example, in one embodiment the multi-environment display data handling logic 309 may determine which of the first display data or the second display data should be transparent, and accordingly provide the configured combined workspace display data 333 to a shared memory space contained within memory 311. In some instances, the first (or other) operating system environment may be called upon to perform graphically intensive application activity such as for example displaying video. In those instances, the multi-environment display data handling logic 309 may pass first display data and/or second display data to the GPU 315 to more efficiently handle video data processing. In other words, the multi-environment display data handling logic 309 makes decisions related to the first display data and second display data, from the corresponding first operating system environment and second operating system environment, and acts accordingly to utilize either shared memory space of the memory 311, or interact with the GPU 315 to generate the combined workspace display data 333. In one example, the second display data associated with the second operating system environment may be handled as overlay data with respect to the first display data associated with the first operating system environment. The multi-environment display data handling logic 309 may also handle graphics information in various formats. For example, GDK (GIMP Drawing Kit) information may be used by one or more operating system environments, while JAVA graphics objects may be used by others. In accordance with the embodiments, the multi-environment display data handling logic 309 utilizes shared memory space of memory 311 to handle various graphics objects, and/or other such display data accordingly, by for example, changing or adjusting object properties to generate the combined workspace display data 333.

Important to understand is that some graphical objects may be afforded various attributes including, but not limited to, state attributes that determine a live or active status of an object, or data displayed by the object. One example is a widget, which may provide an image object that provides real time information. In accordance with the embodiment, such image object state information is preserved, such that the real time information is accordingly shown on the combined workspace image. For example, turning briefly to FIG. 2, an image object, such as window 215, may be a widget associated with the first operating system environment that provides real time information. An example of such a widget is a clock application that shows current time. In accordance with the embodiments, the clock widget would remain active, even while the user interacts with a window object, such as application window 213, associated with the second operating system environment. The use may also switch, i.e. toggle, to a different combined workspace. Upon switching back to the current combined workspace the clock widget would have remained in operation and be shown in its current state (i.e. showing the current time). Also in accordance with the embodiments, switching to a different combined workspace would accordingly also switch to the mapped corresponding home screen as was described with respect to FIG. 1.

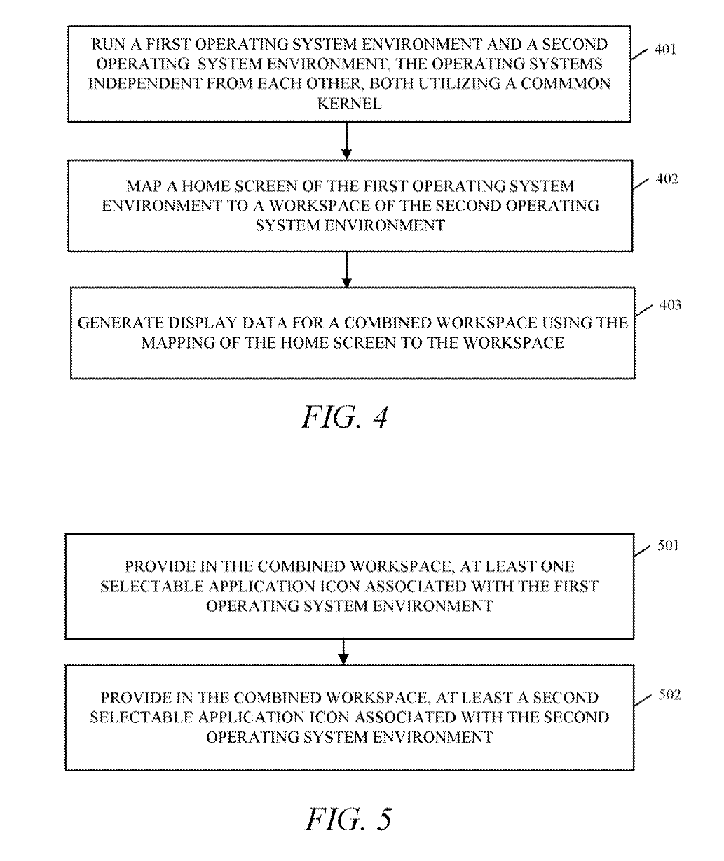

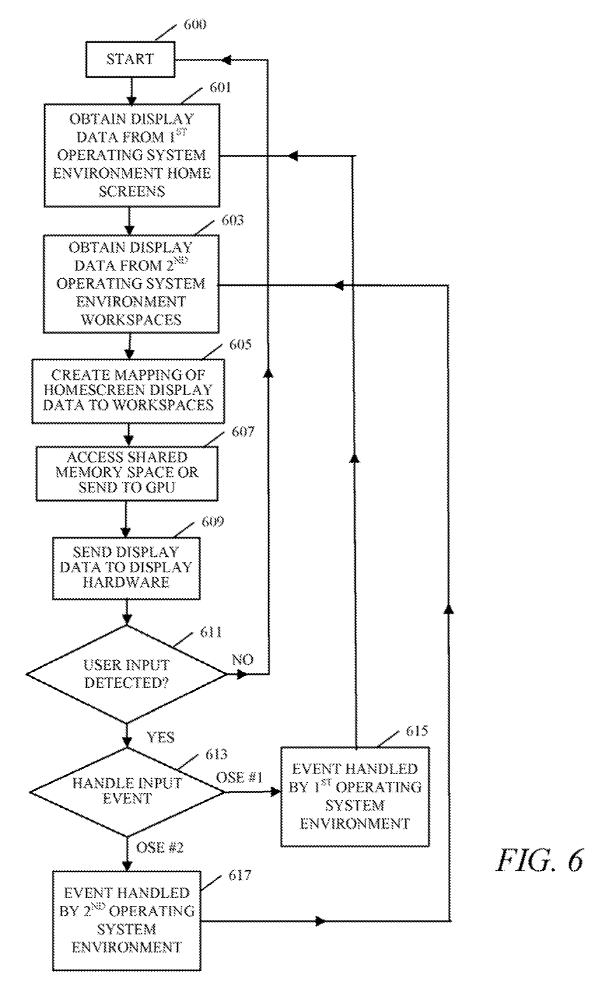

FIG. 4 and FIG. 5 are flowcharts illustrating high level operation of the various embodiments. For example, in 401, the programmable processor may run a first operating system environment and the second operating system environment, the first and second operating system environments independent from each other, both utilizing a common kernel. An example is illustrated in FIG. 3 where the plurality of operating system environments 307, operate in conjunction with the common kernel 305, but are autonomous and independent operating system environments. As shown in 402, the multi-environment display data handling logic 309 may a home screen of the first operating system environment to a workspace of the second operating system environment. In some embodiments, this may include mapping first display data associated with the home screen of the first operating system environment to second display data associated with the workspace of the second operating system environment. As discussed above, the display data may be handled in various ways, such as handling the second display data associated with the second operating system environment as overlay data. That is, the home screen display data may be overlaid onto a background image consisting of the workspace image or vice versa. In 403, the multi-environment display data handling logic 309 generates display data for a combined workspace using the mapping of the home screen to the workspace. For example, the multi-environment display data handling logic 309 may determine what, if any, icons, windows, widgets, or portions of the home screen background image of the first operating system environment are covered or hidden by windows of the second operating system environment workspace. The multi-environment display data handling logic 309 will assign color and/or appropriate transparency, brightness, etc., to image pixels so that the combined workspace image will be properly displayed on the display.

The FIG. 5 flowchart illustrates the functionality shown in FIG. 2. As shown in 501, the workspace may also contain at least one selectable application icon associated with the first operating system environment. For example, as shown in FIG. 2, the combined workspace 209 may include the workspace of the second operating system environment, but may also include icons associated with the first operating system environment. The combined workspace 209 may show various combinations of display data from the home screen of the first operating system environment and the workspace of the second operating system environment. As shown in 502, the embodiments may provide in the workspace, at least a second selectable application icon associated with the second operating system environment. For example, the window 215 shown in FIG. 2 may be any appropriate image object such as an icon associated with the second operating system environment. Among other advantages of the various embodiments, switching/toggling between the combined workspaces is equivalent to switching/toggling to a different home screen of the mobile device 201 display image. For example, in one specific embodiment an Android™ operating system environment home screen of the mobile device 201 is mapped to a Linux® workspace associated with the second operating system environment. For this example, switching to a different Linux® workspace would be equivalent to switching to a different Android™ home screen, because the Android™ home screens are mapped to the Linux® workspaces in accordance with embodiments.

The flowchart of FIG. 6 provides further details of operation of the various embodiments. The process is shown as starting in block 600. The multi-environment display data handling logic 309 may obtain display data from the first operating system environment home screens as shown in 601. In 603, the multi-environment display data handing handling logic 309 may obtain display data from the second operating system environment, for example workspace display data. In 605, a mapping is created between the home screen display data and the workspace display data to create combined workspace display data. As discussed above, one example embodiment maps Android™ operating system environment home screens to Linux® operating system environment workspaces. As shown in 607, the multi-environment display data handling logic 309 may access shared memory space of memory 311, or may send display data to the GPU 315 in accordance with the computational requirements of the display data. For example, video data may be sent to the GPU 315 as appropriate. As shown in 609, the combined workspace display data 333 is sent to the display hardware, such as the hardware 319 shown in FIG. 3. Based on the combined workspace display data 333, the various embodiments are able to handle graphical user input operations that take place using the combined workspace image. For example, a user of the peripheral device 327 may employ touchscreen functionality of the display 325, or may use a mouse cursor to select and drag and drop objects on, and around, the combined workspace. As shown in 611, if user input is detected, an event handler of the multi-environment display data handling logic 309 determines whether the event is related to the first operating system environment or the second operating system environment (or another of the plurality of operating system environments 307). This operational decision may be accomplished in conjunction with the common kernel 305 which handles fundamental hardware level operations. Thus, for a first operating system environment related event, the event is handled by the first operating system environment as shown in 615, and related display data from the first operating system environment is obtained by the multi-environment display data handling logic in 601. Likewise as shown in 617, if the event is related to operation of the second operating system environment, it is handled accordingly and display data from the second operating system environment is obtained as shown in 603. When the system is static, and no user input is detected in 611, the process continues to monitor for changes in the first and second display data accordingly. For example, widgets associated with the first operating system may be active and require the combined workspace display data to be updated and refreshed. In other words, any active data that may have an impact on the first display data associated with the first operating system environment, or the second display data associated with the second operating system environment, will be updated and accordingly reflected by the combined workspace display data in accordance with various embodiments.

Among other advantages of various embodiments disclosed herein, the user experience is enhanced when accessing application data or other data using one or more operating system environments. Although the embodiments have been described using examples related to two operating system environments, the various embodiments are not limited to only two operating system environments and can incorporate many operating system environments as illustrated by the plurality of operating system environments 307 shown in FIG. 3. Therefore the multi-environment display handling logic 309, in accordance with the embodiments, may handle display data from any number of operating system environments, where the operating system environments all utilize the common kernel 305. Returning briefly to FIG. 2, the plurality of icons 205 shown on the combined workspace 209 may be associated with a single operating system environment, or may be related to various operating system environments. Likewise, image objects such as the application window 213, and window 215, may be any appropriate image objects and may be associated with any of a number of operating system environments in accordance with various embodiments herein disclosed.

The various embodiments also include computer readable memory that may contain executable instructions, for execution by at least one processor, that when executed, cause the at least one processor to operate in accordance with the multi-environment display handling logic 309 functionality herein described. The computer readable memory may be any suitable non-volatile, non-transitory, memory such as, but not limited to, programmable chips such as EEPROMS, flash ROM (thumb drives), compact discs (CDs) digital video disks (DVDs), etc., that may be used to load executable instructions or program code to other processing devices or electronic devices such as those that may benefit from the features of the herein described embodiments. The executable instructions may also include the various operating system environments and the common kernel.

While various embodiments have been illustrated and described, it is to be understood that the invention is not so limited. Numerous modifications, changes, variations, substitutions and equivalents will occur to those skilled in the art without departing from the scope of the present invention as defined by the appended claims.

What is claimed is:

1. A method comprising:
running a first operating system environment and a second operating system environment, the first and second operating system environments being independent from each other, both operating system environments utilizing a common kernel;
mapping a home screen of the first operating system environment to a workspace of the second operating system environment; and
generating display data for a combined workspace using the mapping of the home screen to the workspace.

2. The method of claim 1, comprising:
generating the display data for the combined workspace, including at least one selectable application icon for selecting an application associated with the first operating system environment, and at least a second selectable application icon for selecting an application associated with the second operating system environment.

3. The method of claim 1, comprising:
mapping a plurality of home screens of the first operating system environment, to a corresponding plurality of workspaces of the second operating system environment; and
generating display data for a plurality of corresponding combined workspaces using a corresponding mapping, corresponding to each combined workspace, with at least one combined workspace including at least one selectable application icon of an application of the first operating system environment.

4. The method of claim 1, wherein mapping a home screen of the first operating system environment to a workspace of the second operating system environment, comprises:
mapping positional coordinates of the home screen to positional coordinates of the workspace.

5. The method of claim 1, wherein mapping a home screen of the first operating system environment to a workspace of the second operating system environment, comprises:
mapping an Android™ home screen with a Linux® workspace where the first operating system environment is an Android™ operating system environment and the second operating system environment is a Linux® operating system environment.

6. The method of claim 5, comprising:
mapping each Android™ home screen, of a plurality of Android™ home screens, to a corresponding workspace of a plurality of corresponding Linux® workspaces.

7. The method of claim 3, comprising:
switching, in response to selection input, from a first combined workspace of the plurality of combined workspaces, to a second combined workspace of the plurality of combined workspaces; and
maintaining a current state of a least one application window or at least one widget, such that returning to the first combined workspace in response to another selection input, returns the at least one application window or the at least one widget to the same current state.

8. The method of claim 1, comprising:
displaying the combined workspace on a display, the combined workspace including first display data associated with the first operating system environment, having at least one selectable application icon associated with the first operating system environment, and second display data associated with the second operating system environment, including at least a second selectable application icon associated with the second operating system environment, both icons being selectable within the combined workspace.

9. The method of claim 1, comprising:
displaying the combined workspace on a display, the combined workspace including first display data, having at least one active widget associated with the first operating system environment, and second display data having at least a second selectable application icon associated with the second operating system environment, both the widget and the icon being within the combined workspace.

10. An apparatus comprising:
at least one processor, operative to run a first operating system environment and a second operating system environment, the first and second operating system environments being independent from each other, with both operating system environments utilizing a common kernel; and
multi-environment display data handling logic, operative to:
map a home screen of the first operating system environment to a workspace of the second operating system environment; and
generate display data for a combined workspace using the mapping of the home screen to the workspace.

11. The apparatus of claim 10, wherein the multi-environment display data handling logic is operative to:
generate the display data for the combined workspace, including at least one selectable application icon for selecting an application associated with the first operating system environment, and at least a second selectable application icon for selecting an application associated with the second operating system environment.

12. The apparatus of claim 10, wherein the multi-environment display data handling logic is operative to:
map a plurality of home screens of the first operating system environment, to a corresponding plurality of workspaces of the second operating system environment; and
generate display data for a plurality of corresponding combined workspaces using a corresponding mapping, corresponding to each combined workspace, with at least one combined workspace including at least one selectable application icon of an application of the first operating system environment.

13. The apparatus of claim 10, wherein the multi-environment display data handling logic is operative to map a home screen of the first operating system environment to a workspace of the second operating system environment, by:
mapping positional coordinates of the home screen to positional coordinates of the workspace.

14. The apparatus of claim 10, wherein the multi-environment display data handling logic is operative to map a home screen of the first operating system environment to a workspace of the second operating system environment, including mapping an Android™ home screen with a Linux® workspace where the first operating system environment is an Android™ operating system environment and the second operating system environment is a Linux® operating system environment.

15. The apparatus of claim 14, wherein the multi-environment display data handling logic is operative to.
map each Android™ home screen, of a plurality of Android™ home screens, to a corresponding workspace of a plurality of corresponding Linux® workspaces.

16. The apparatus of claim 10, wherein the multi-environment display data handling logic is operative to:
switch, in response to selection input, from a first combined workspace of the plurality of combined workspaces, to a second combined workspace of the plurality of combined workspaces; and
maintain a current state of a least one application window or at least one widget, such that returning to the first combined workspace in response to another selection input, returns the at least one application window or the at least one widget to the same current state.

17. The apparatus of claim 10, comprising:
a display, operatively coupled to the at least one processor, the display operative to:
display the combined workspace, the combined workspace including first display data associated with the first operating system environment, having at least one selectable application icon associated with the first operating system environment, and second display data associated with the second operating system environment, including at least a second selectable application icon associated with the second operating system environment, both icons being selectable within the combined workspace.

18. The apparatus of claim 10, comprising:
a display, operatively coupled to the at least one processor, the display operative to:
display the combined workspace, the combined workspace including first display data, having at least one active widget associated with the first operating system environment, and second display data having at least a second selectable application icon associated with the second operating system environment, both the widget and the icon being within the combined workspace.

19. A computer readable, non-volatile, non-transitory memory, comprising:
executable instructions for execution on at least one processor, that when executed cause the at least one processor to:
run a first operating system environment and a second operating system environment, the first and second operating system environments being independent from each other, both operating system environments utilizing a common kernel;
map a home screen of the first operating system environment to a workspace of the second operating system environment; and
generate display data for a combined workspace using the mapping of the home screen to the workspace.

20. The computer readable, non-volatile, non-transitory memory, of claim 19, wherein the executable instructions, when executed, further cause the at least one processor to:
map a plurality of home screens of the first operating system environment, with a corresponding plurality of workspaces of the second operating system environment; and
generate display data for a plurality of corresponding combined workspaces using a corresponding mapping, corresponding to each combined workspace, with at least one combined workspace including at least one selectable application icon of an application of the first operating system environment.
